(19) United States
(12) Patent Application Publication
(10) Pub. No.: US 2003/0041446 A1
(43) Pub. Date: Mar. 6, 2003

(54) Retaining tool of heat radiator

(76) Inventors: Tao Chian, Sanchung City (TW); Hzen-Hsing Lee, Sanchung City (TW); Tsung Hsien Wu, San Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/946,349

(22) Filed: Sep. 6, 2001

(51) Int. Cl. H01R 3/00; B23P 19/00

(52) U.S. Cl. 29/729; 29/758

(57) ABSTRACT

The present invention proposes an improved retaining tool of heat radiator, which comprises a retaining tool for fixing a heat radiator on a chip socket. An L-shaped supporting board is disposed on the retaining tool. A tool is mounted on the supporting board to apply a force on the supporting board so that the retaining tool can be easily be loosened from the chip socket.

### FIELD OF THE INVENTION

The present invention relates to an improved retaining tool of heat radiator and, more particularly, to a retaining tool having an L-shaped supporting board. The retaining tool is used to fix a heat radiator on a chip socket. When the retaining tool is to be detached, a tool is mounted on the supporting board to apply a force so that the retaining tool can be easily be loosened from the socket.

### BACKGROUND OF THE INVENTION

Along with continual enhancement of the functions of electronic devices nowadays, heat generated therein becomes more and more. Generally speaking, a heat radiator is used to radiate out large amount of heat so that the electronic device can operate normally. A retaining tool must be used to fix a heat radiator on an electronic device to exploit the maximal effect of the heat radiator.

As shown in FIGS. 1 and 2, a conventional retaining tool 10a for fixing a heat radiator comprises a long press rod portion 11a, which is slightly bent downwards. Front and rear ends of the press rod portion 11a extend vertically downwards to form sheet-shaped retaining portions 12a. A hole 121a to be retained on a chip socket 30a is disposed on the lower half portion of each of the retaining portions 12a. The holes 121a are retained with corresponding retaining bodies 31a on the chip socket 30a to fix a heat radiator 20a on the chip socket 30a, as shown in FIG. 2. However, when the retaining tool 10a is to be detached, because the surface of the retaining portion 12a is flat and abuts against the chip socket 30a, and the retaining tool 10a is placed in a central thin slot of the heat radiator 20a, it is difficult to find a place for applying a force to easily loosen the retaining portions 12a from the chip socket 30a. It is necessary to stick a tool into a gap between the hole 121a of the retaining portion 12a and the retaining body 31a of the chip socket 30a to wrench the retaining tool, resulting in much inconvenience. Moreover, other electronic devices may be easily damaged due to an improper force when the retaining tool is wrenched.

Accordingly, the above retaining tool for fixing a heat radiator has inconvenience and drawbacks in practical use. The present invention aims to resolve the problems in the prior art.

### SUMMARY OF THE INVENTION

The primary object of the present invention is to provide an improved retaining tool of heat radiator, which can be easily loosened from a chip socket without damaging other electronic devices.

To achieve the above object, the present invention provides an improved retaining tool of heat radiator, which comprises a long sheet-shaped press rod portion slightly bent downwards. Front and rear ends of the press rod portion are extended and bent downwards to form a front retaining portion and a rear retaining portion, respectively. A hole to be retained with a chip socket is disposed at the lower half portion of each of the two retaining portions. An L-shaped supporting board is disposed above the hole of the front retaining portion. When the retaining tool is to be detached from the chip socket, it is only necessary to mount a tool on the supporting board to let the back face of the tool shore up the top end of the front retaining portion, and then to place the tool at an end point of the supporting board for applying a force on the supporting board so that the front retaining portion can be detached from the chip socket. The retaining tool can thus be easily loosened from the chip socket. Moreover, other electronic devices will not be damaged because only the front retaining portion of the retaining tool is applied with force.

The various objects and advantages of the present invention will be more readily understood from the following detailed description when read in conjunction with the appended drawing, in which:

### BRIEF DESCRIPTION OF THE DRAWINGS

FIG. 1 is a perspective view of a retaining tool in the prior art;

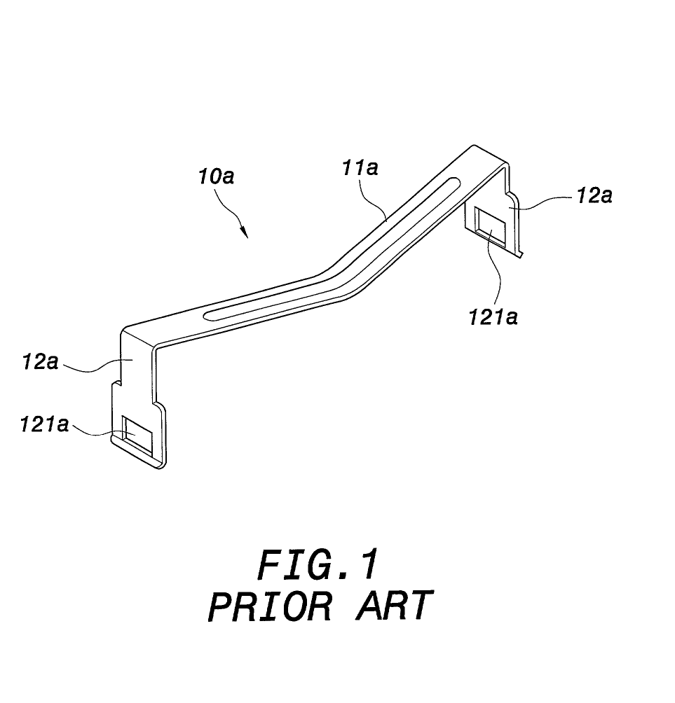

FIG. 2 is a cross-sectional view showing the situation that a retaining tool in the prior art is used to fix a heat radiator on a chip socket;

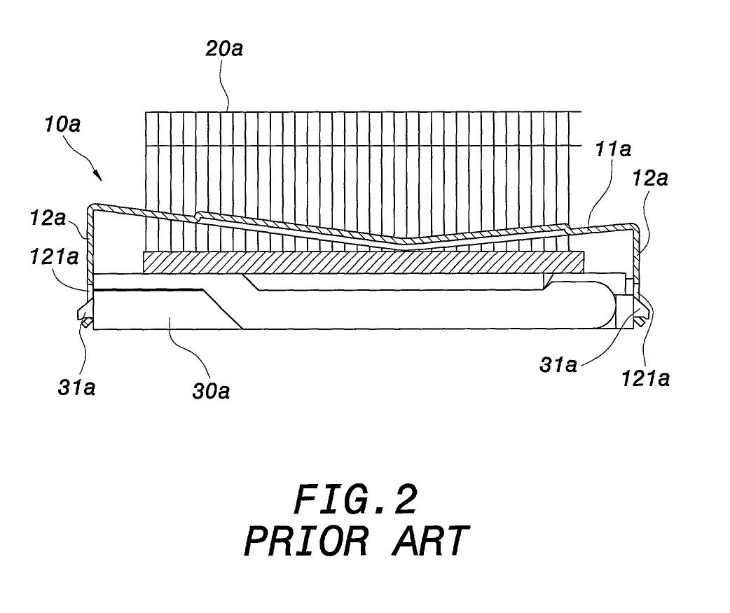

FIG. 3 is a perspective view of the present invention;

FIG. 4 is a diagram showing the detachment action of the present invention;

FIG. 5 is a perspective view of another embodiment of the present invention;

FIG. 6 is a diagram showing the detachment action according to another embodiment of the present invention; and

FIG. 7 is a perspective view of yet another embodiment of the present invention.

### DETAILED DESCRIPTION OF THE PREFERRED EMBODIMENTS

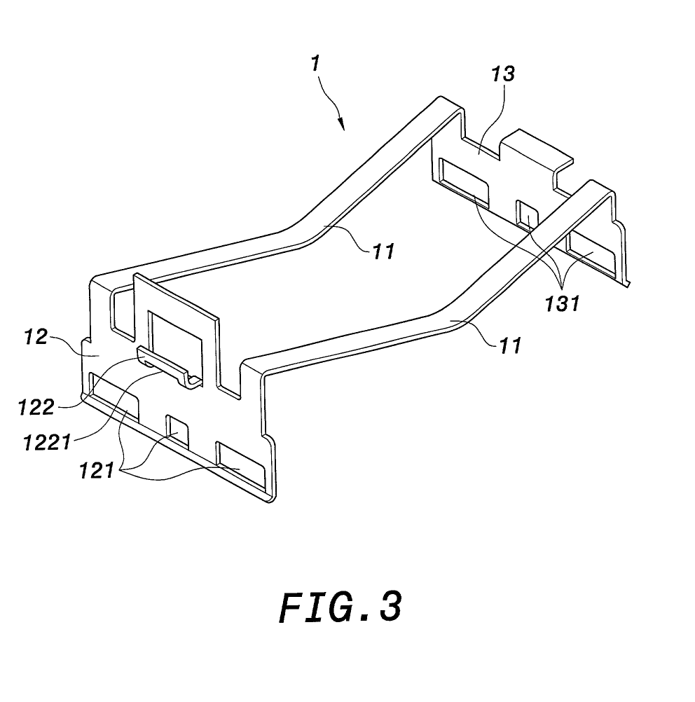

As shown in FIG. 3, the present invention provides an improved retaining tool 1 of heat radiator. The retaining tool 1 is integrally made of metallic material. The retaining tool 1 comprises a press rod portion 11, which comprises two long sheets having the same length and slightly bent downwards. Front ends of the two long sheets of the press rod portion 11 join downwards a front retaining portion 12. Rear ends of the two long sheets of the press rod portion 11 join downward a rear retaining portion 13. A front retaining hole 121 and a rear retaining hole 131 are disposed at lower portions of the front retaining portion 12 and the rear retaining portion 13, respectively. The top end of the front retaining portion 12 extends to form a sheet having an L-shaped supporting board 122. A hole 1221 is disposed on the supporting board 122.

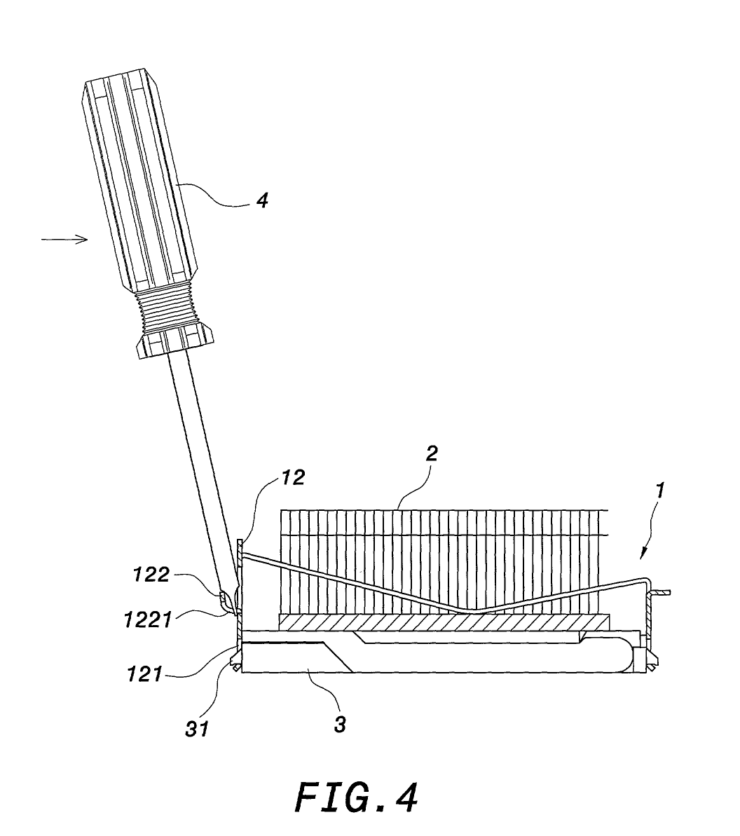

As shown in FIG. 4, the retaining tool 1 is used to fix a heat radiator 2 on a chip socket 3. When the retaining tool 1 is to be detached, a tool 4 not easily deformed and having a lower end smaller than the hole 1221 of the supporting board 122 is exploited. The lower end of the tool 4 is placed in the hole 1221, and the tool 4 abuts rearwards against the top end of the front retaining portion 12 to be applied with a force. The lower end of the tool 4 will move forwards to shore up the supporting board 122, and the front retaining hole 121 of the front retaining portion 12 will be detached from a retaining body 31 of the chip socket 3, thereby easily detaching the whole retaining tool 1 from the chip socket 3 to remove the heat radiator 2 from the chip socket 3.

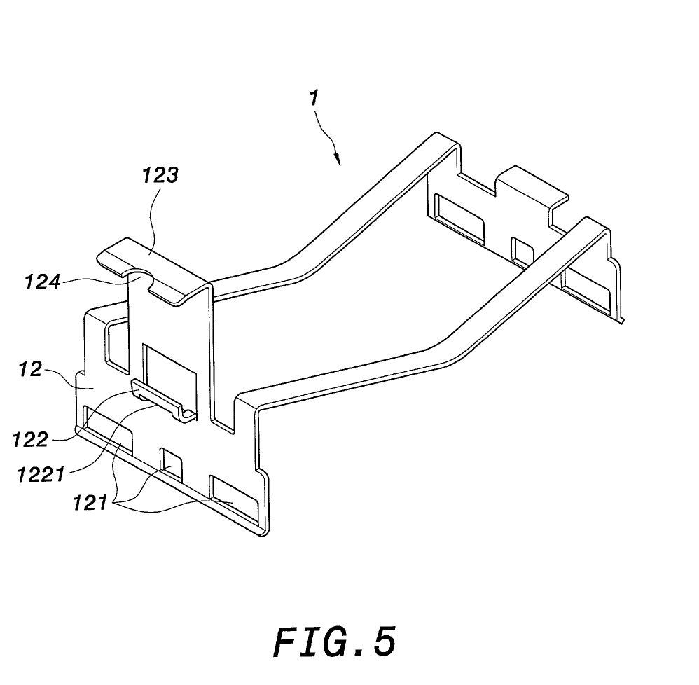

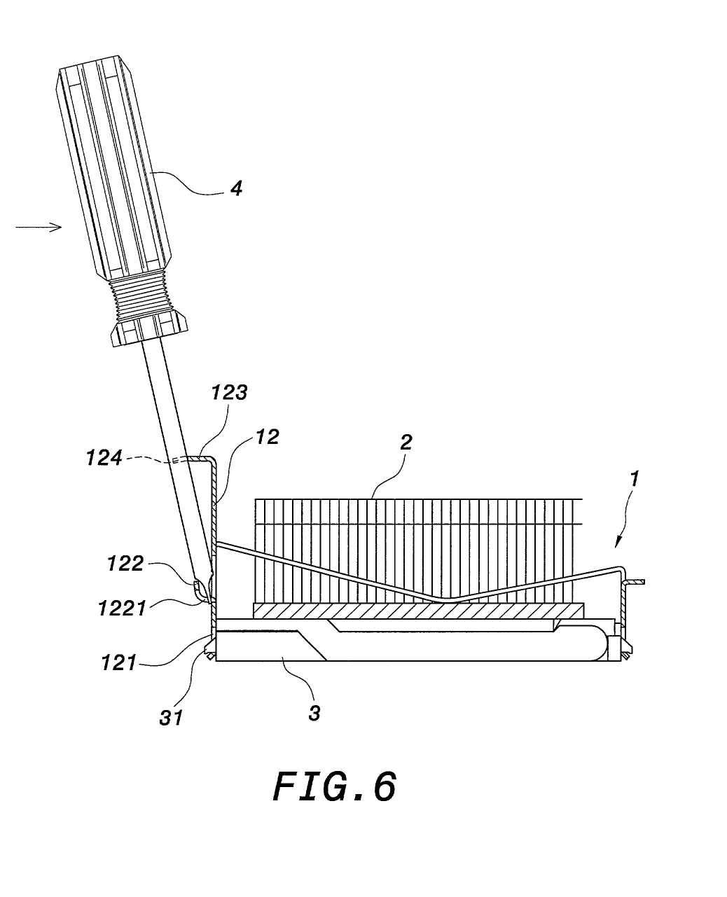

FIGS. 5 and 6 show another embodiment of the present invention. As shown in the figures, a long sheet extends upwards from the supporting board 122 of the retaining tool 1. A pressing board 123 extends forwards from the top end of the long sheet. A semi-circular positioning hole 124 is disposed at the front end of the pressing board 123, and the positioning hole 124 is open at the front end thereof. When the retaining tool 1 already retained on the chip socket 3 is to be detached, the tool 4 having a lower end slightly smaller than the hole 1221 on the supporting board 122 is similarly exploited. After the lower end of the tool 4 is placed in the hole 1221, the tool 4 leans against the positioning hole 124 to let the tool 4 not easily slip. The tool 4 is then pressed rearwards to wrench the front retaining portion 12 rearwards to let the front retaining hole 121 detach from the retaining body 31 of the chip socket 3, thereby removing the heat radiator 2 from the chip socket 3.

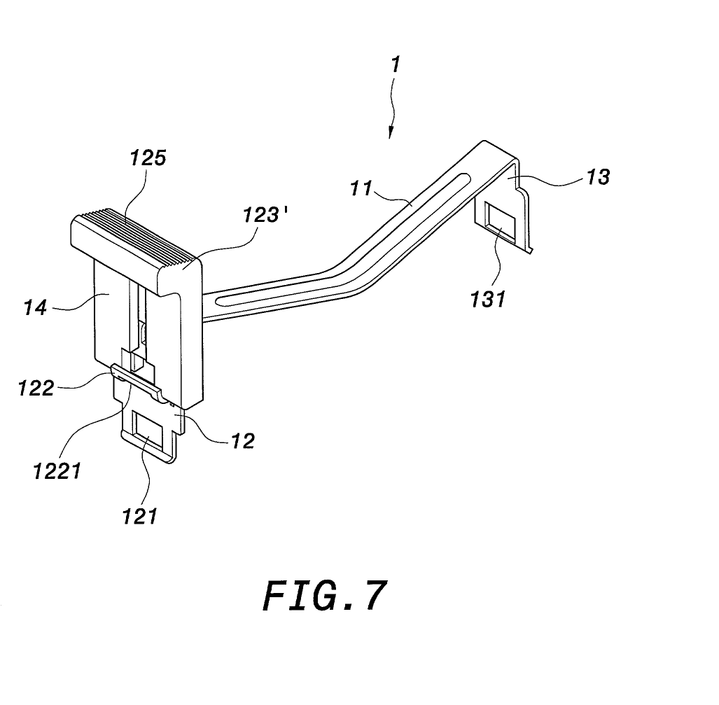

FIG. 7 shows yet another embodiment of the present invention. As shown in the figure, a retaining tool 1 comprises a press rod portion 11 composed of a long sheet, which is slightly bent downwards. Front and rear ends of the press rod portion 11 are extended and bent downwards to form a front retaining portion 12 and a rear retaining portion 13, respectively. A front retaining hole 121 is similarly disposed at the lower portion of the front retaining portion 12. A rear retaining hole 131 is similarly disposed at the lower portion of the rear retaining portion 13. An L-shaped supporting board 122 is disposed above the front retaining hole 121 of the front retaining portion 12. A hole 1221 is disposed on the supporting board 122. A protection shell 14 integrally made of plastic material is sleeved onto the top end of the front retaining portion 12. The top end of the protection shell 14 extends forwards to form a pressing board 123'. The front end and the bent position of the pressing board 123' are circular arc-shaped to facilitate hold, hence reducing discomfort generated when holding metallic material. Non-slip stripes 125 are disposed on the surface of the pressing board 123' so that the retaining tool 1 will not easily slip off from hand when being held.

To sum up, the present invention provides an improved retaining tool of heat radiator, whereby a tool can be mounted on an L-shaped supporting board thereof to apply a force, thereby easily loosening the retaining tool from the chip socket without damaging other electronic devices.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An improved retaining tool of heat radiator, said retaining tool being integrally made of metallic material and comprising a long sheet-shaped press rod portion, a front end of said press rod portion joining downwards a front retaining portion, a rear end of said press rod portion joining downwards a rear retaining portion, retaining holes being disposed at lower half portions of said two retaining portions, an L-shaped supporting board being disposed on said front retaining potion.

2. The improved retaining tool of heat radiator as claimed in claim 1, wherein said press rod portion comprises a long sheet.

3. The improved retaining tool of heat radiator as claimed in claim 1, wherein said press rod portion comprises two long sheets.

4. The improved retaining tool of heat radiator as claimed in claim 1, wherein said press rod portion is slightly bent downwards.

5. The improved retaining tool of heat radiator as claimed in claim 1, wherein a long sheet extends upwards from said supporting board of said front retaining potion, and a pressing board extends forwards from a top end of said long sheet.

6. The improved retaining tool of heat radiator as claimed in claim 5, wherein a semi-circular positioning hole is disposed at a front end of said pressing board, and said positioning hole is open at a front end thereof.

7. The improved retaining tool of heat radiator as claimed in claim 1, wherein an integrally formed protection shell is sleeved onto a top end of said front retaining portion, a pressing board extends forwards from a top end of said protection shell, and a front end and a bent position of said pressing board are circular arc-shaped.

8. The improved retaining tool of heat radiator as claimed in claim 7, wherein non-slip stripes are disposed on a surface of said pressing board.
